(19) United States
(12) Patent Application Publication
(10) Pub. No.: US 2023/0380320 A1
(43) Pub. Date: Nov. 30, 2023

(54) SOIL CULTIVATOR

(71) Applicant: Engelbert Rath, JR., Pfatter (DE)

(72) Inventor: Engelbert Rath, JR., Pfatter (DE)

(21) Appl. No.: 18/322,415

(22) Filed: May 23, 2023

(30) Foreign Application Priority Data
May 24, 2022 (DE) 102022113040.1

(51) Int. Cl. A01B 63/00; A01B 19/02; A01B 39/04; A01B 39/18; A01B 39/22; A01B 49/02; A01B 63/16

(52) U.S. Cl. CPC A01B 63/004; A01B 19/02; A01B 39/04; A01B 39/18; A01B 39/22; A01B 49/02; A01B 63/006; A01B 63/16; A01B 63/22

(57) ABSTRACT

A soil cultivator comprises a frame attachable to a tractor and at least one processing unit attached to the frame. The processing unit has a frame-like element, a first soil cultivation tool attached to the frame-like element via a first connecting element, a second soil cultivation tool attached to the frame-like element via a second connecting element, and a swiveling axis element. The first soil cultivation tool and the second soil cultivation tool are arranged on different sides of the swiveling axis element. The first connecting element has a first annular section, and the second connecting element has a second annular section. The first and the second connecting elements are arranged so that they can swivel around the swiveling axis element such that a change in the extent of the frame-like element can effect a change in the distance between the first and the second soil cultivation tools.

### CROSS-REFERENCE TO RELATED APPLICATIONS

This application claims the benefit of German Patent Application No. DE 10 2022 113 040.1, filed May 24, 2022, the disclosure of which is hereby incorporated herein in its entirety by reference.

### BACKGROUND OF THE INVENTION

### Field of the Invention

The present invention relates to a soil cultivator for mechanical weed control.

### Background & Description of Related Art

Soil cultivation devices for mechanical weed control between rows of cultivated plants are known in a wide range of variants. Hoeing devices, and in particular hoe shares or cultivator sweeps, are the central component in such soil cultivators, and serve to cut through or loosen the roots of weeds and similar undesired vegetation in the ground. To this end, the hoe shares are pulled through the soil at a slight depth, wherein depth guide wheels are usually provided, which allow the hoe shares to follow the soil contours.

It can here happen that so many roots remain embedded in larger chunks of soil that the weeds continue to grow, in particular if the chunks of soil do not dry out during humid weather. For this reason, cultivator sweeps are often combined with harrow tines, which are used on the one hand to comminute the clods and chunks of earth loosened by the hoe shares, and on the other hand to pull the weeds to the soil surface. In both cases, the roots of the weeds are exposed, dry out and can no longer grow. For example, such soil cultivators are known from EP 0 426 960 B1, DE 35 21 785 C2 or U.S. Pat. No. 5,168,936.

The aim of any weed control and also of any mechanical weed control is to remove the weeds in rows of cultivated plants as completely as possible. It is here especially important that weeds growing relatively near the crops also be removed. However, weed control must not cause relevant damage to the crop plants. This results in the problem that the hoe shares and harrow tines described above should be guided in such a way as to also control weeds growing near the crops, if possible without damaging the crops themselves.

When using the soil cultivators on agricultural land, in particular on fields, it would thus be advantageous during mechanical weed control if the line along which hoe shares and harrow tines are guided could be adjusted to the real conditions of the respective cultivation area.

In this conjunction, FR 2 359 570 A1 discloses a soil cultivator with a base frame and several subframes arranged in the base frame and designed like a parallelogram. At least two hoe shares are here attached to each of the subframes, wherein the distance between them transverse to the traveling direction can be adjusted, specifically by a respective actuating lever that compresses or stretches the corresponding subframe.

Known from DE 817 828 B is a device for mounting soil cultivators, e.g., goose feet, cultivator tines, etc., wherein the individual toolholders of the soil cultivators are adjustably mounted. Further provided is an adjusting means, the actuation of which makes it possible to simultaneously and uniformly change the spacing of the toolholders. The spacing of the toolholders is changed by means of “Nuremberg scissors”, the links of which can be moved toward and away from each other using a spindle with a right-hand and left-hand thread.

However, the use of these soil cultivators has proven to be unfeasible. The essential disadvantage to the described approaches lies in the fact that the soil cultivation process for adjusting the distance between the hoe shares must be interrupted. During each necessary adjustment of the distance between the hoe shares, the tractor must thus be stopped, and the distance must be adjusted manually. This results in an extremely time-consuming effort, which cannot be implemented in practice in an economically justifiable manner. In addition, the soil cultivation tools cannot be brought close enough to the crops with sufficient precision.

Weed control is especially important as crops begin to grow. As long as the crops only have a low growth height, they can be overwhelmed especially easily by fast-growing weeds, and thereby become especially heavily damaged. At this point in time, mechanical weed control faces a very special challenge. In their initial growth stage, the young crops are especially sensitive to any type of mechanical affects, and can also be very easily buried by heaped up earth.

In particular, in an early growth stage of the crops, the goal of mechanical weed control is thus to completely remove all weeds growing in close proximity to the young crops. However, weed control can lead to the young crops becoming damaged to a relevant extent.

For this reason, there is a need for soil cultivators for mechanical weed control in rows of cultivated plants which enable effective weed control even in an initial growth phase of the crops.

### SUMMARY OF THE INVENTION

As characterized in the claims, the object of the invention is to provide a soil cultivator for mechanical weed control in rows of cultivated plants which enables effective weed control even in an initial growth phase of the crops.

According to the invention, this object is solved by the soil cultivator according to claim 1. Additional advantageous details, aspects and embodiments of the present invention will be apparent from the dependent claims, the description, the examples, and the drawings.

The present invention provides a soil cultivator for mechanical weed control in rows of cultivated plants. The soil cultivator comprises a frame attachable to a tractor for movement along a traveling direction, and at least one soil processing unit attached to the frame. The soil processing unit has a frame-like element, wherein the extent of the frame-like element transverse to the traveling direction can be changed. In addition, the processing unit has at least one first soil cultivation tool attached to the frame-like element via a first connecting element, at least one second soil cultivation tool attached to the frame-like element via a second connecting element, and a swiveling axis element having a cylindrical design at least sectionally in cross section. The first soil cultivation tool and the second soil cultivation tool are arranged transverse to the traveling direction on different sides of the swiveling axis element. The first connecting element has a first annular section that encloses the swiveling axis element like a sleeve, and the second connecting element has a second annular section that encloses the swiveling axis element like a sleeve. The first and second connecting elements are arranged so that they can swivel around the swiveling axis element in such a way that changing the extent of the frame-like element transverse to the traveling direction can effect a change in the distance between the first soil cultivation tool and the second soil cultivation tool transverse to the traveling direction.

Provided according to the invention is a frame-like element, whose extent transverse to the traveling direction can be changed. This variable extent can be enabled both by a hinged design of the frame-like element, and by the elastic properties of the material, which at least partially can comprise the frame-like element. As will be described in even more detail below, the shape of the frame-like element can be adjusted by moving adjusting means, thereby making it possible to move cultivation tools arranged on the frame-like element, such as cultivator sweeps, also referred to as hoe shares, or harrow tines, in the broadest sense, but in particular to change the distance between several such cultivation tools, and thereby adjust them to the real conditions of a specific field. In particular, this makes it possible to change the line along which cultivator sweeps and harrow tines are guided, in an easy manner without any major expenditure of time.

The core of the invention lies in providing soil cultivation tools that are attached to the frame-like element via connecting elements, and also to provide a swiveling axis element having a cylindrical design at least sectionally in cross section. The connecting elements each have an annular section that encloses the swiveling axis element like a sleeve, and can therefore be swiveled around the swiveling axis element. In this way, the distance between two soil cultivation tools arranged in a direction transverse to the traveling direction on different sides of the swiveling axis element can be altered by changing the extent of the frame-like element.

The soil cultivation tools can be attached to the frame-like element via the connecting elements in two different ways. One possibility involves fastening crosswise, which results in a scissor-like swiveling of the soil cultivation tools around the swiveling axis element. In this type of fastening, the first connecting element and the second connecting element cross each other in the area of the swiveling axis element.

In this case, a decrease in the extent of the frame-like element transverse to the traveling direction leads to a decrease in the distance between the first soil cultivation tool and the second cultivation tool transverse to the traveling direction, or an increase in the extent of the frame-like element transverse to the traveling direction leads to an increase in the distance between the first soil cultivation tool and the second cultivation tool transverse to the traveling direction.

On the other hand, fastening can also take place via connecting elements that do not cross, which results in the soil cultivation tools swiveling like spreader pliers. In this case, a decrease in the extent of the frame-like element transverse to the traveling direction leads to an increase in the distance between the first soil cultivation tool and the second soil cultivation tool transverse to the traveling direction, or an increase in the extent of the frame-like element transverse to the traveling direction leads to a decrease in the distance between the first soil cultivation tool and the second soil cultivation tool transverse to the traveling direction.

Swiveling the connecting elements creates the option of providing a transmission or reduction. Therefore, the soil cultivation tools do not follow the change in the frame-like element to an identical extent, but rather with what is in principle a freely selectable transmission. Given a correspondingly selected reduction, it thus becomes possible to change the distance between two soil cultivation tools in very small increments and in an extremely precise manner.

The connecting elements provided according to the invention are preferably comprised of three sections. Apart from the first annular section that encloses the swiveling axis element like a sleeve, the first connecting element has a section that is connected with the frame-like element and with the first annular section, and a lower section that is connected with the first annular section and with the first soil cultivation tool. Analogously thereto, apart from the second annular section that encloses the swiveling axis element like a sleeve, the second connecting element has an upper section that is connected with the frame-like element and with the second annular section, and a lower section that is connected with the second annular section and with the second soil cultivation tool.

According to an especially preferred embodiment, the extent of the upper section of the first connecting element in a direction going from the frame-like element to the first annular section is greater than the extent of the lower section of the first connecting element in a direction going from the first annular section to the first soil cultivation tool. Apart from that, the extent of the upper section of the second connecting element in a direction going from the frame-like element to the second annular section is greater than the extent of the lower section of the second connecting element in a direction going from the second annular section to the second soil cultivation tool. Changing the extent of the frame-like element transverse to the traveling direction can thus affect a comparatively smaller change in the distance between the first soil cultivation tool and the second soil cultivation tool transverse to the traveling direction.

As clear to the expert, the expression “in a direction going from the frame-like element to the annular section” is not to be understood as any direction going from any point of the frame-like element to any point of the annular section, but rather as a vector that connects the area in which the upper section of the connecting element is connected with the frame-like element with the area in which the upper section of the connecting element is connected with the annular section. Analogously thereto, the expression “in a direction going from the annular section to the first soil cultivation tool” is not to be understood as any direction going from any point of the annular section to any point of the first soil cultivation tool, but rather as a vector that connects the area in which the lower section of the connecting element is connected with the annular section with the area in which the lower section of the connecting element is connected with the soil cultivation tool. Therefore, the extent of the upper or the lower section is understood as the length of a vector lying essentially inside of the connecting element, which extends between the end points of the respective section.

Expressed in simple terms, then, the respective section of the respective connecting element that extends above the swiveling axis element is longer than the section that extends below the swiveling axis element in the described embodiment. Given a change in the extent of the frame-like element transverse to the traveling direction, this change is thus translated into a comparatively smaller change in the distance between the two soil cultivation tools attached to the lower sections of the connecting elements transverse to the traveling direction. This yields quite significant advantages for weed control in rows of cultivated plants. Specifically, this is because a relatively rough change in the extent of the frame-like element can be converted into a very small, extremely precise change in the distance between the soil cultivation tools. This makes it possible for the soil cultivation tools to approach the crops very precisely to allow use, in particular, with young crops in an early growth phase. Weeds are removed with a high efficiency without damaging the plants.

According to an alternative embodiment, the extent of the upper section of the first connecting element in a direction going from the frame-like element to the first annular section is smaller than the extent of the lower section of the first connecting element in a direction going from the first annular section to the first soil cultivation tool. Apart from that, the extent of the upper section of the second connecting element in a direction going from the frame-like element to the second annular section is smaller than the extent of the lower section of the second connecting element in a direction going from the second annular section to the second soil cultivation tool. Changing the extent of the frame-like element transverse to the traveling direction can thus affect a comparatively larger change in the distance between the first soil cultivation tool and the second soil cultivation tool transverse to the traveling direction. This embodiment can be advantageous if the soil cultivator is used between the rows of cultivated plants. The distance between the soil cultivation tools can already be strongly changed by slightly changing the extent of the frame-like element. As a result, it is easy to make an adjustment to different alley widths between rows of cultivated plants, and also an adjustment to fields with different rows of cultivated plants, and thus different alley widths.

The first and the second soil cultivation tools preferably involve a first and a second angle chopper, wherein the first angle chopper is attached to the lower section of the first connecting element, and the second angle chopper is attached to the lower section of the second connecting element. By using angle choppers, earth with rampant weeds can be moved away from young crops especially effectively on both sides.

Let it be explicitly clarified at this juncture that the present invention is not limited to the use of angle choppers as soil cultivation tools connected with the frame-like element via connecting elements. Any kind of soil cultivation tools can basically be used, such as for example coulters, cultivator sweeps, hoe shares or harrow tines. In light of the early growth stage of the crops and the associated sensitivity of the plants to mechanical influences, it may here prove advantageous to give the soil cultivation tools smaller dimensions than usual.\

According to an especially preferred embodiment, a first and a second depth guide wheel are provided on the processing unit, wherein the first depth guide wheel and the second depth guide wheel are arranged transverse to the traveling direction on different sides of the swiveling axis element. The first depth guide wheel is attached to the lower section of the first connecting element, and the second depth guide wheel is attached to the lower section of the second connecting element. Analogously to the procedure described above in conjunction with the soil cultivation tools connected with the frame-like element via connecting elements, a change in the extent of the frame-like element transverse to the traveling direction can thus effect a change in the distance between the first depth guide wheel and the second depth guide wheel transverse to the traveling direction. In this case, the distance between the two depth guide wheels can be adjusted to the size of the individual plants in the crop row. During weed control in an early growth stage of the plants, the rows are processed in such a way that the individual plants are located between the two depth guide wheels. Care must here be taken that the wheels do not damage the plants. This is easily enabled by the variable distance between the wheels.

Apart from that, adjusting the distance between the two depth guide wheels makes it possible to move the depth guide wheels relatively close to the crops. The slight distance between the depth guide wheels and plant row is associated with the advantage of a highly precise depth guidance. The closer the wheels run to the plants, the greater the probability that the height of the ground over which the wheels run is identical or very similar to the height of the ground where the plants extend upward therefrom. The soil cultivation tools, and in particular the soil cultivation tools arranged on the frame-like element via the connecting elements, can thereby be guided through the soil with the exact penetration depth desired.

Since the two depth guide wheels are attached to the lower section of the respective connecting element, and these connecting elements are rigidly designed in a general embodiment, the camber of the depth guide wheels changes when the connecting elements are swiveled. Proceeding from a basic setting without camber, an increase in the extent of the frame-like element transverse to the traveling direction leads to an increase in the distance between the depth guide wheels and to a positive camber of the wheels in the case of crossing connecting elements, i.e., in the case of a scissor-like swiveling. Conversely, a decrease in the extent of the frame-like element transverse to the traveling direction leads to a decrease in the distance between the depth guide wheels and to a negative camber of the wheels.

Proceeding from a basic setting without camber, an increase in the extent of the frame-like element transverse to the traveling direction leads to a decrease in the distance between the depth guide wheels and to a negative camber of the wheels in a case where connecting elements do not cross, i.e., in a case where swiveling takes places like spreader pliers. Conversely, a decrease in the extent of the frame-like element transverse to the traveling direction leads to an increase in the distance between the depth guide wheels and to a positive camber of the wheels.

The varying camber of the depth guide wheels opens another option for targeted soil cultivation. This is because if the wheels have a positive camber, the running surfaces of the wheels move loose soil toward the plant row to a certain extent. Conversely, if the depth guide wheels have a negative camber, earth is moved outwardly away from the plant row.

The connecting elements can also be equipped with a hinge, so that the camber of the wheels can be prevented from changing given a change in the distance between the wheels.

The processing unit is preferably equipped with a support element. This support element is attached to the swiveling axis element. The support element especially preferably involves a variable-length support element. A variable-length support element can affect a height adjustment of the depth guide wheels relative to the frame-like element. Given an increase in the length of the support element, the distance between the depth guide wheels and the frame-like element increases. Conversely, a decrease in the length of the support element leads to a decrease in the distance between the depth guide wheels and the frame-like element. The support element can also be movably attached to the swiveling axis element, wherein in particular the end section of the support element can wrap around the swiveling axis element. In this case, the end section of the support element is designed so that it can move along the swiveling axis element in its axial direction.

According to an especially preferred embodiment, the processing unit has at least a first and a second harrow tine, wherein the first and the second harrow tines are attached to the swiveling axis element, wherein the first and the second harrow tines are preferably designed so that they can be folded between a parked position and a usable position. Fastening the harrow tines to the swiveling axis element prevents the distance between the two harrow tines from changing given a change in the extent of the frame-like element transverse to the traveling direction. The two harrow tines are rather attached to the swiveling axis element at a predetermined distance from each other. The distance between the two harrow tines is selected according to the size of the crops in an initial growth phase. During soil cultivation in a plant row, i.e., during soil cultivation in which the two depth guide wheels are guided in such a way that the plant row is always located between the two wheels, the two harrow tines always process the plant row on both sides of the individual plants. This means that soil is loosened on both sides of each crop, and any weeds growing there are killed. Since this type of cultivation must be performed with very special care, so as not to damage the young crops, use is preferably made of harrow tines that have smaller dimensions by comparison to the usual harrow tines. Of course, the harrow tines cannot be too delicate in design, so as prevent frequent damage or destruction of the tines, but the diameter and elastic bendability of the tines can be selected in such a way as to be adjusted to the low growth height of the plants.

The harrow tines can be swivelably designed in a known manner. In this case, an adjusting device allocated to the harrow tines is provided, which can be used to adjust the prestress of the harrow tines. This adjusting device advantageously consists of a wire or a cord, which is attached to the harrow tines, deflected via a frame pipe, and attached to another frame pipe. Rotating the frame pipe winds the wire or cord around the frame pipe, thereby applying a corresponding tractive force on the harrow tines. If a drive unit is allocated to such an adjusting device, wherein the drive unit especially preferably involves an electric or hydraulic actuator that can be actuated by means of a control device, the prestress of the harrow tines, and thus the setting of the tine pressure, can take place from the tractor even during soil cultivation. If necessary, the tine pressure can be easily and quickly adjusted to the respective conditions on the field, wherein the soil cultivation process does not have to be interrupted. However, the harrow tines can also be adjusted manually.

As already mentioned, the variable extent of the frame-like element can be enabled both by a hinged design of the frame-like element and by the elastic properties of a material of which the frame-like element is at least partially made in this case. According to a preferred embodiment, the frame-like element at least sectionally consists of an elastic material. The elastic properties of the material of which the frame-like element consists or consists for the most part are crucial to the functionality of such a frame-like element. In general, and within the framework of the present text, elasticity is understood as the property of a body or material to change its shape when exposed to a force, and return to its original shape once no longer exposed to the force.

Any kind of material with elastic properties can basically be used. While each material is known to have elastic properties to some extent, reference is made within the framework of the present text to materials whose elastic properties can be used with an effort that is reasonable in practice. Of course, the expert is clearly aware of the fact that the elastic properties of a macroscopic body do not depend exclusively on the elastic properties of the material of which this body is made, but also on the dimensions of the body. Therefore, when reference is made within the framework of the present text to a frame-like element consisting of spring steel, for example, it is clear to the expert that this frame-like element is used during soil cultivation in the agricultural sector. The expert will conclude that the frame-like element does not involve either meter-thick steel blocks or metal films with a thickness in the micrometer range. The expert will instead casually select the dimensions of the frame-like element in such a way that the element has the desired elastic properties on the one hand, while having a stable enough design to withstand the stresses during the cultivation of agricultural land on the other.

The elastic material preferably involves an elastomer, a thermoplastic, a rubber, in particular hard rubber, or steel, in particular spring steel. The steel preferably involves a stainless steel, especially preferably a chromium-nickel stainless steel. Especially preferably involved is stainless steel 1.4310. Hardox® steel also has especially good properties.

A frame-like element without a hinged design preferably consists of one piece, or is assembled out of several partial elements that are immovable relative to each other and firmly connected with each other. A one-piece design of such a frame-like element means that the entire element consists of an elastic material. If the frame-like element is assembled out of several partial elements, at least individual partial elements consist of the elastic material. The individual elastic partial elements are immovable relative to each other and firmly connected with each other. The individual partial elements can be connected using any type of fixing element, i.e., clamps, screws, rivets, etc. As a rule, these fixing elements do not consist of an elastic material, but rather of the metal materials common for the respective type of fixing element. As clear to the expert, however, the desired and required elastic properties of the frame-like element are not influenced by the partial sections or fixing elements consisting of nonelastic materials.

The frame-like element can have a variety of shapes. An open and a closed shape of the frame-like element are basically possible. In the case of an open shape, the frame-like element has a C-type or U-type or some other distinctive open shape with two ends. In the case of a closed shape, the frame-like element is continuous in design. Therefore, it has a self-contained shape, for example an oval, a circle, a rectangle, a rhombus, or some other distinctive closed shape without an end. A rectangular shape or a rhomboid shape is especially suitable for a hinged frame-like element. In this case, the hinged connecting points of the individual partial elements of the frame-like element make up the corners of the rectangle or the rhombus.

According to an especially preferred embodiment, a plurality of additional cultivation tools is provided on the processing unit, wherein the cultivation tools are connected with the frame-like element of the processing unit by one or several connecting means, wherein the cultivation tools preferably involve cultivator sweeps, colters and harrow tines. This embodiment ensures the soil cultivator can be used not just for soil cultivation in a crop row, but rather also for soil cultivation between rows of cultivated plants. In this case, the cultivation tools arranged on the connecting elements that can swivel like scissors are either removed entirely or swiveled into a parked position. The same holds true for the harrow tines attached to the swiveling axis element.

The present invention comprises two different groups of soil cultivation tools. On the one hand, the invention provides for a first and a second soil cultivation tool, which are attached to the frame-like element via connecting elements, wherein the distance between them can be changed by changing the extent of the frame-like element transverse to the traveling direction and swiveling the connecting elements. These swivelably attached soil cultivation tools—and also the harrow tines arranged on the swiveling axis element—are provided for soil cultivation above the plant row, meaning in an early growth stage of the plants. The second group of soil cultivation tools involves tools that are connected directly with the frame-like element via connecting means, and provided between the plant rows for soil cultivation. While the distance between the tools can also be changed for these tools, this change always corresponds to the change in the extent of the frame-like element. When using the processing unit between the plant rows, the swivelable cultivation tools and the harrow tines arranged on the swiveling axis element are folded into a parked position or completely removed.

According to an especially preferred embodiment, the frame-like element runs in a plane. The frame-like element is elastically deformed by the movement of a first and a second adjusting means in such a way that the extent of the frame-like element changes transverse to the traveling direction. In this way, a change can be affected in the distance between cultivation tools optionally arranged on the frame-like element. It goes without saying to the expert that this change in the distance between the cultivation tools is to take place in a horizontal direction. After all, weed control between rows of cultivated plants in a later growth phase is intended to also fight weeds growing close to the crops. In order to achieve this, the cultivation tools must be moved as close to the crops as possible without damaging them. This objective can be pursued by changing the distance between the cultivation tools in a horizontal direction.

However, a change in the distance between the cultivation tools attached directly to the frame-like element via an elastic deformation of the frame-like element can be made most effectively by having the frame-like element be formed essentially in one plane. The frame-like element is especially preferably arranged on the processing unit in such a way that the plane of the frame-like element is formed in a horizontal direction. In this case, any movement of the adjusting means can be directly proportionately converted into a change in the distance between the cultivation tools attached directly to the frame-like element via connecting means.

The frame-like element can also have at least one loop, wherein the loop runs in the plane of the frame-like element or perpendicular to the plane of the frame-like element. In a loop arranged in the plane of the frame-like element, the elastic deformability of the frame-like element is improved. A cultivation tool, in particular a hoe share, can advantageously be secured in the area of a loop arranged perpendicular to the plane of the frame-like element, which then can flexibly follow any potential bumps in the ground.

According to another, especially preferred embodiment, the processing unit additionally has:
a first, movably designed adjusting means, wherein the first adjusting means is connected with the frame-like element via at least a first connecting part, and a second, movably designed adjusting means, wherein the second adjusting means is connected with the frame-like element via at least a second connecting part, and
at least one adjusting unit for executing a movement of the first and the second adjusting means, wherein the movement of the first and the second adjusting means makes it possible to change the extent of the frame-like element transverse to the traveling direction.

According to an especially preferred embodiment, the adjusting unit can affect a linear movement of the first and the second adjusting means oriented transverse to the traveling direction, wherein the movement of the first adjusting means can be effected so as to be oriented antiparallel to the movement of the second adjusting means. In order to effect the change provided according to the invention in the extent of the frame-like element transverse to the traveling direction in an especially easy manner, it is especially preferred that the first adjusting means and the second adjusting means move in an opposite direction. A movement of the two adjusting means varying in strength in the same direction or even a movement of the adjusting means in any direction that only has to have a component in the plane of the frame-like element can basically also be converted into a change in the extent of the frame-like element transverse to the traveling direction. However, it is constructively the least complex to transmit a movement of the first and the second adjusting means oriented in an opposite direction to the frame-like element. The adjusting unit can especially preferably affect a linear movement of the first and the second adjusting means oriented transverse to the traveling direction. The movement of the first adjusting means can very especially preferably be affected antiparallel to the movement of the second adjusting means. As a result of this embodiment, moving the adjusting means by a certain amount can produce an especially strong deformation of the frame-like element transverse to the traveling direction.

During a movement of the adjusting means connected with the frame-like element, this movement is converted into a change in the shape of the frame-like element. If the adjusting means are subsequently moved back into their original position, the frame-like element also assumes its original shape and position due to its elastic properties or its hinges. Since the extent of the frame-like element is changed by the movement of the first and the second adjusting means transverse to the traveling direction, this makes it possible to effect both a swiveling of the connecting elements around the swiveling axis, and thus the change according to the invention in the distance between the first soil cultivation tool and the second soil cultivation tool transverse to the traveling direction, and a change in the distance between cultivation tools arranged on the frame-like element. These changes in distance can be reversed owing to the elastic properties of the frame-like element or owing to the hinges of the frame-like element.

Therefore, the adjusting means connected with the frame-like element via a respective at least one connecting part causes a movement of the adjusting means to be converted into a movement of the frame-like element. The movement of the adjusting means is here transmitted via the connecting parts to the frame-like element, whose elastic properties or whose hinges make it possible to adjust the width of the frame-like element transverse to the traveling direction.

In the most general case, the movement of the adjusting means can be affected by an adjusting unit allocated to the adjusting means via drive means. For example, the drive means can involve a hydraulic cylinder, which is preferably equipped with a distance measuring system. However, a separate adjusting unit can also be allocated to each adjusting means.

A preferred embodiment provides a pipe arranged transverse to the traveling direction, wherein the pipe has at least a first guide sleeve and a second guide sleeve. The outside of the first guide sleeve is provided with a first force transmission means, and the outside of the second guide sleeve is provided with a second force transmission means. In this case, the connection between the first, movably designed adjusting means and the frame-like element is realized by virtue of the fact that the first, movably designed adjusting means is connected with the first guide sleeve via the first force transmission means, and the first guide sleeve is connected with the frame-like element via the first connecting part. The connection between the second, movably designed adjusting means and the frame-like element is formed by connecting the second, movably designed adjusting means with the second guide sleeve via the second force transmission means, and by connecting the second guide sleeve with the frame-like element via the second connecting part.

According to this embodiment, the frame-like element with a variable shape owing to its elastic properties is combined with a device that produces an adjustment in the shape of the frame-like element via a linear movement of sleeves along a pipe.

As a result of the guide sleeves provided on the pipe and their connection with the frame-like element, a movement of the guide sleeves is converted into a deformation of the frame-like element. The movement of the guide sleeves is here transmitted via connecting parts to the frame-like element, whose elastic properties make it possible to adjust the width of the frame-like element transverse to the traveling direction. The movement of the guide sleeves is caused by two adjusting means, a respective one of which is connected with a respective guide sleeve. The movement of the adjusting means is here transmitted to the guide sleeves via a respective force transmission means.

In a case where the guide sleeves are attached to a pipe arranged transverse to the traveling direction, it becomes especially easy to constructively realize the soil cultivator. Much the same holds true for the transmission of the movement of the adjusting means to the guide sleeves via a respective force transmission means. This transmission can be realized especially easily by having the first adjusting means involve a first adjusting means designed so that it can move transverse to the traveling direction, and by having the second adjusting means involve a second adjusting means designed so that it can move transverse to the traveling direction. In this case, the movement of the adjusting means can be converted by the force transmission means directly into a movement of the first guide sleeve and the second guide sleeve oriented transverse to the traveling direction. If the two guide sleeves move toward each other, the extent of the frame-like element transverse to the traveling direction is decreased. If the two guide sleeves move away from each other, the extent of the frame-like element transverse to the traveling direction is increased.

Therefore, special preference goes to embodiments with a first adjusting means designed so that it can move transverse to the traveling direction, and a second adjusting means designed so that it can move transverse to the traveling direction. The adjusting means preferably involve pipes arranged transverse to the traveling direction.

The movably designed adjusting means can also be realized by a first and a second threaded sleeve, which interact with a first and a second engaging means. The first and the second engaging means are attached to a pipe arranged transverse to the traveling direction. The first engaging means is here engaged with the first threaded sleeve having a left-hand female thread, and the second engaging means is engaged with the second threaded sleeve having a right-hand female thread, wherein the first threaded sleeve and the second threaded sleeve are each connected with the frame-like element via at least one connecting part. Rotating the pipe around its longitudinal axis moves the threaded sleeves relative to each other in such a way that the transmission of the movement via the connecting parts to the frame-like element changes the extent of the frame-like element transverse to the traveling direction.

Especially preferred are embodiments in which the first guide sleeve and the second guide sleeve are designed so that they can be moved in opposite directions.

Within the framework of the present invention, a “pipe” is understood as an elongated element, which can both have a hollow design and be designed as a massive solid. An element with a circular, oval, or even square cross section can here be involved. Therefore, use can be made of a cylindrical body as well as a square pipe.

The guide sleeves arranged on the pipe fit around the pipe in an essentially precise manner. Depending on the formation of the pipe, the guide sleeves have a varying cross section. For example, if the pipe involves a cylinder, the guide sleeves are designed as hollow cylinders. If the pipe is a profiled pipe with basically any number of edges desired, the guide sleeves have a corresponding number of edges.

The guide sleeves arranged on the pipe need not completely encompass the pipe, but can also be designed with a non-enclosed shape. In the case of a cylindrical pipe or a pipe with an oval cross section, then, the guide sleeves can be C-shaped, for example. In the case of a square pipe, the guide sleeves can essentially be U-shaped, wherein the angles between the web and leg of the “U” measure 90°, meaning that the transition is angular in design. In addition, short projections that overlap the pipe must be provided at the ends of the legs, so as to ensure a secure fit of the guide sleeve on the pipe.

The frame of the soil cultivator preferably has a known three-point tower, which can be used to connect the soil cultivator with a three-point linkage of the tractor.

The first and the second force transmission means especially preferably involve a first and a second linkage part, wherein the first and second linkage parts vary in length. This enables a firm connection between guide sleeves and adjusting means in a structurally especially easy manner. Due to the varying length of the first and second linkage parts, the adjusting means can be arranged offset relative to each other in the traveling direction. As clear to the expert, the first and the second force transmission means can have a certain flexibility in the vertical direction, and can be non-deformable in design only in the horizontal direction. This is because the connection between guide sleeves and adjusting means need only be firm in design in the horizontal direction for purposes of force transmission. Because the processing unit is usually arranged on the frame so that it can move in a vertical direction, a vertical movement of the pipe relative to the adjusting means may take place. This vertical movement can be enabled in various ways. For example, force transmission means can be equipped with a hinge, or designed as a telescoping rod. However, the connecting parts that connect the guide sleeves with the frame-like element can also be flexibly designed in a vertical direction. Hinges or telescoping rods can be used in this case as well.

A high material load arises during use of the soil cultivator according to the invention on the field. In particular the up and down movements of the processing unit can cause premature wear to the means attached to the processing unit. The use of guide sleeves arranged on a pipe provides the option of giving this pipe a hard chrome-plated design. For this reason, the guide sleeves are not expected to undergo any wear and tear. Also provided is the possibility of designing the pipe as a frame pipe, or firmly connecting it with a frame pipe.

The frame-like element can be shaped like a parallelogram as viewed from the top. The special advantage to a frame-like element shaped like a parallelogram lies in the fact that the elastic properties or hinges of the frame-like element can be used as effectively as possible to change the extent of the frame-like element transverse to the traveling direction.

In additional embodiments, the frame-like element is designed like a rhombus. As known, the rhombus involves a convex square, with four sides of equal length. Rhombuses are special forms of parallelograms. A frame-like element in the form of a rhombus has the advantages mentioned in conjunction with a parallelogram-like shape. In addition, the rhombus has a high degree of symmetry, thereby making it possible to identically change the shape of the frame-like element on both sides of the swiveling axis element.

In general, embodiments in which the frame-like element has a symmetrical axis in the traveling direction are especially preferred. In this case, the frame-like element is assembled symmetrically to the swiveling axis element. Since the first adjusting means is especially preferably connected via the first connecting part with a part of the frame-like element arranged on one side of the symmetrical axis, and since the second adjusting means is especially preferably connected via the second connecting part with the part of the frame-like element arranged on the other side of the symmetrical axis, a symmetrical movement of the two adjusting means also produces a symmetrical deformation of the frame-like element.

The adjusting unit especially preferably involves an electric or hydraulic actuator that can be actuated by means of a control device. As a result, the movement of the adjusting means can take place from the tractor, even during soil cultivation. If necessary, the width of the frame-like element can thus be easily and quickly adjusted to the respective conditions on the field, wherein the soil cultivation process does not have to be interrupted. In addition, the adjusting unit can be equipped with a distance measuring system known from prior art.

An electric actuator can expediently comprise a gear motor arranged on the frame, e.g., which is coupled by way of a belt or chain drive with at least one setting wheel for rotating at least one drive shaft connected with an adjusting means. A hydraulic drive that is especially advantageous in terms of energy supply, and thus best suited for driving even large soil cultivation devices with a plurality of processing units, can comprise a hydraulic cylinder arranged on the frame, which is coupled via a traction means arrangement with at least one setting wheel for rotating at least one drive shaft connected with an adjusting means.

However, the adjusting unit can also involve a manually operated element. In this case, the movement of the adjusting means cannot take place from the tractor during soil cultivation. Rather, the soil cultivation process must be interrupted for adjusting the width of the frame-like elements to the respective conditions on the field, so as to move the adjusting unit manually. The disadvantage of interrupting soil cultivation is offset by a significant reduction in manufacturing costs for the soil cultivator accompanied by an improved robustness and resistance to loads during use.

A manually operable element as the adjusting unit also effects a linear movement of the first and the second adjusting means oriented transverse to the traveling direction, wherein the movement of the first adjusting means is oriented antiparallel to the movement of the second adjusting means. In this way, the movement of the adjusting means is converted in a directly proportional manner into a corresponding change in the extent of frame-like elements transverse to the traveling direction.

According to another especially preferred embodiment of the present invention, a plurality of processing units with a plurality of frame-like elements is arranged on the frame. The extent of the frame-like elements transverse to the traveling direction is especially preferably changed in an identical manner by a movement of the first adjusting means and the second adjusting means. This embodiment takes into account the fact that modern agricultural equipment has a width of several meters, so that a plurality of alleys between rows of cultivated plants can be cultivated simultaneously in one operation. All frame-like elements are synchronously changed, and the cultivation tools are synchronously moved with the described embodiment. This makes it possible to directly react to a change in the conditions or plant species of the cultivation area noticed by a farmer on the tractor by correspondingly adjusting the width of all frame-like elements.

According to another embodiment of the present invention, in a case where a plurality of processing units with a plurality of frame-like elements is arranged on the frame, a pipe arranged transverse to the traveling direction with a number of first and second engaging means corresponding to the number of processing units is provided. Each of the first engaging means is engaged with a respective first adjusting means that has a left-hand female thread and is designed like a first threaded sleeve, and each of the second engaging means is engaged with a respective second adjusting means that has a right-hand female thread and is designed like a second threaded sleeve. As a result of the engaging means provided on the pipe and their combination with threaded sleeves equipped with variously threaded female threads, rotating the pipe in the one direction effects an increase in the distance between the two threaded sleeves, and rotating the pipe in the other direction leads to a decrease in the distance between the two threaded sleeves. The movement of the threaded sleeves is transmitted via connecting parts to the frame-like element, whose elastic properties or hinges allow the width of the frame-like element to be adjusted transverse to the traveling direction.

This takes place in the described manner for both one individual processing unit and a plurality of processing units. In the case of a plurality of processing units, rotating the pipe around its longitudinal axis changes the frame-like elements in an identical manner, as a result of which the extent of the plurality of frame-like elements transverse to the traveling direction changes in an identical manner. This embodiment also takes into account the fact that modern agricultural equipment has a width of several meters, making it possible to cultivate a plurality of alleys between rows of cultivated plants simultaneously in one operation. All threaded sleeves are synchronously moved and all frame-like elements are thereby synchronously deformed with the described embodiment. This makes it possible to directly react to a change in the conditions or plant species of the cultivation area noticed by a farmer on the tractor by correspondingly adjusting the width of all frame-like elements.

During use for weed control between rows of cultivated plants in a later growth phase, a tractor moves the soil cultivator in a traveling direction parallel to the plant rows. A processing unit is allocated to each alley between two rows of cultivated plants. When the crop cultivation device is used between rows of cultivated plants, leading front colters create depressions of several centimeters in the soil. Three cultivator sweeps are drawn through the soil at a shallow depth, and in the process cut through the roots of the rampant weeds in the alley between the crops. Two harrow tines till up the soil near the crops, while simultaneously comminuting the clods and chunks of earth loosened by the cultivator sweeps and pulling the weeds to the earth's surface. Compacted soil near the crops is here broken up by the harrow tines. Two trailing colters move soil toward the crops, thereby refilling the initially created depressions and heaping earth near the crops.

During the described weed control between rows of cultivated plants in a later growth phase, the cultivation tools arranged on the connecting elements that can swivel like scissors are either removed entirely or swiveled into a parked position. The same holds true for the harrow tines attached to the swiveling axis element.

Since each of the processing units e.g., twelve processing units each having a respective two harrow tines, three cultivator sweeps and four colters, which are all moved together with the respective frame-like element, complete soil cultivation between the rows of cultivated plants can be adjusted to the specific local conditions. The distance between the harrow tines and the distance between the colters and the distance between the cultivator sweeps can be adjusted to the field to be cultivated.

If a plurality of processing units with a plurality of frame-like elements is arranged on the frame, a movement of the first adjusting means and the second adjusting means deforms the frame-like elements in such a way that the extent of the plurality of frame-like elements transverse to the traveling direction changes in an identical manner. As a result, a plurality of alleys between rows of cultivated plants can be cultivated simultaneously in one operation. This makes it possible to directly react to a change in the conditions or plant species of the cultivation area noticed by a farmer on the tractor by correspondingly adjusting the width of all frame-like elements.

### BRIEF DESCRIPTION OF THE DRAWINGS

The invention will be described in more detail below based upon exemplary embodiments in conjunction with the drawings. Let it be expressly noted, however, that the invention is not to be confined to the indicated examples. Shown on:

FIG. 1 is a schematic, top plan view of part of a processing unit of a soil cultivator according to the invention;

FIG. 2 is a schematic, side perspective view of a processing unit of a soil cultivator according to the invention; and

FIG. 3 is a schematic, top plan view of the processing unit in FIG. 1, with a changed extent of the frame-like element.

### DETAILED DESCRIPTION OF THE PREFERRED EMBODIMENTS

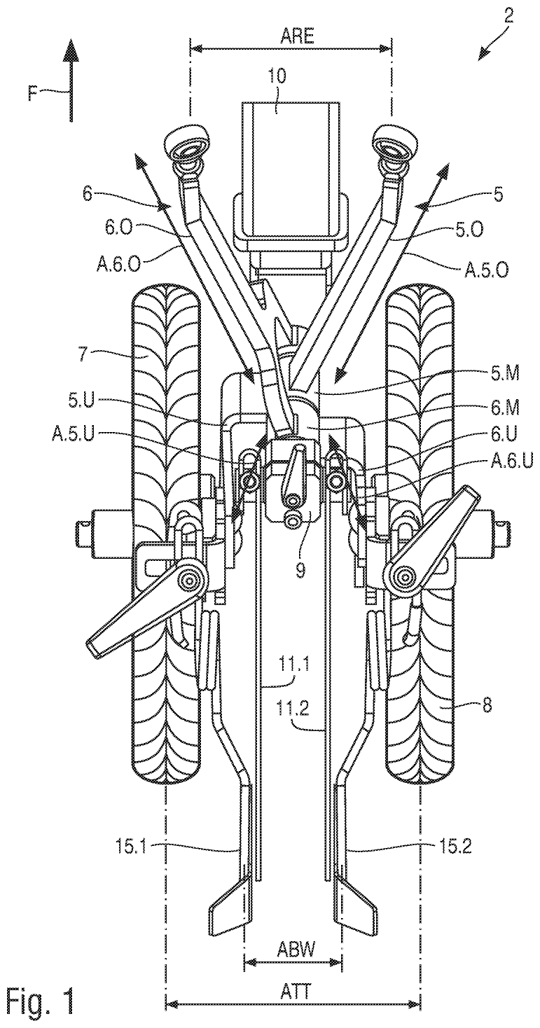

FIG. 1 presents a schematic view of part of a processing unit 2 of a soil cultivator for mechanical weed control in rows of cultivated plants according to the invention. The soil cultivator has a frame (not shown) that can be attached to a tractor to be moved along a traveling direction F, to which the processing unit 2 is attached.

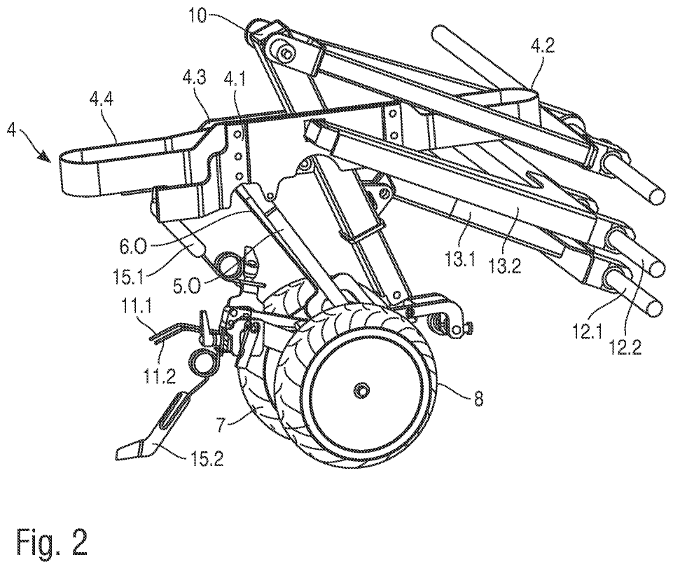

The processing unit 2 has a frame-like element 4 (see FIG. 2), whose extent transverse to the traveling direction can be changed. A first soil cultivation tool 15.1 is attached to the frame-like element 4 via a first connecting element 5. The eyelet shown at the upper end of the first connecting element on FIG. 1 provides a means for fastening the first connecting element 5 with the frame-like element 4.

A second soil cultivation tool 15.2 is attached to the frame-like element 4 via a second connecting element 6. The eyelet shown at the upper end of the second connecting element provides a means for fastening the second connecting element 6 with the frame-like element 4.

In addition, the processing unit 2 has a swiveling axis element 9 having a cylindrical design at least sectionally in cross section, wherein the first soil cultivation tool 15.1 and the second soil cultivation tool 15.2 are arranged transverse to the traveling direction F on different sides of the swiveling axis element 9.

The first soil cultivation tool 15.1 and the second soil cultivation tool 15.2 are designed as angle choppers in the exemplary embodiment shown on FIG. 1, which in the version depicted move soil away from the crops. The first angle chopper 15.1 is attached to the lower section 5.U of the first connecting element 5, and the second angle chopper 15.2 is attached to the lower section 6.U of the second connecting element 6.

The first connecting element 5 comprises a first annular section 5.M that encloses the swiveling axis element 9 like a sleeve, an upper section 5.O connected with the frame-like element 4 and with the annular section 5.M, and a lower section 5.U connected with the annular section 5.M and with the first soil cultivation tool 15.1.

The second connecting element 6 comprises a second annular section 6.M that encloses the swiveling axis element 9 like a sleeve, an upper section 6.O connected with the frame-like element 4 and with the annular section 6.M, and a lower section 6.U connected with the annular section 6.M and with the second soil cultivation tool 15.2.

In the exemplary embodiment shown on FIG. 1, the first and the second connecting element 5, 6 cross each other in the area of the swiveling axis element 9, and can therefore be swiveled around the swiveling axis element 9 like scissors. An increase in the extent of the frame-like element ARE transverse to the traveling direction F thus effects an increase in the distance between the first soil cultivation tool and the second cultivation tool ABW transverse to the traveling direction F. Accordingly, a decrease in the extent of the frame-like element 4 transverse to the traveling direction effects a decrease in the distance between the first soil cultivation tool and the second soil cultivation tool transverse to the traveling direction.

Swiveling the connecting elements 5, 6 creates the option of providing a transmission or reduction. The soil cultivation tools 15.1, 15.2 do not follow the change in the frame-like element 4 to an identical extent, but rather with what is in principle a freely selectable transmission. Given a correspondingly selected reduction, it thus becomes possible to change the distance between the soil cultivation tools 15.1, 15.2 in very small increments and in an extremely precise manner.

In the embodiment shown on FIG. 1, the extent of the upper section 5.O of the first connecting element 5 in a direction A.5.O going from the frame-like element 4 to the annular section 5.M is greater than the extent of the lower section 5.U of the first connecting element 5 in a direction A.5.U going from the annular section 5.M to the first soil cultivation tool 15.1. The extent of the upper section 6.O of the second connecting element 6 in a direction A.6.O going from the frame-like element 4 to the annular section 6.M is greater than the extent of the lower section 6.U of the second connecting element 6 in a direction A.6.U going from the annular section 6.M to the second soil cultivation tool 15.2.

In the embodiment shown on FIG. 1, then, the respective section 5.O, 6.O of the respective connecting element that extends above the swiveling axis element 9 is longer than the section 5.U, 6.U that extends below the swiveling axis element 9. Given a change in the extent of the frame-like element ARE transverse to the traveling direction F, this change is thus translated into a comparatively smaller change in the distance ABW between the two soil cultivation tools 15.1, 15.2 attached to the connecting elements transverse to the traveling direction F. This yields quite significant advantages for weed control in rows of cultivated plants. Specifically, this is because a relatively rough change in the extent of the frame-like element 4 can be converted into a very small, extremely precise change in the distance between the soil cultivation tools 15.1, This makes it possible for the soil cultivation tools 15.1, 15.2 to approach the crops very precisely, to include in particular young crops in an early growth phase. Weeds are removed with a high efficiency without damaging the plants.

A first and a second depth guide wheel 7, 8 are arranged on the processing unit 2 shown on FIG. 1, wherein the first depth guide wheel 7 and the second depth guide wheel 8 are arranged transverse to the traveling direction F on different sides of the swiveling axis element 9. The first depth guide wheel 7 is here attached to the lower section 5.U of the first connecting element 5, and the second depth guide wheel 8 is attached to the lower section 6.U of the second connecting element 6. A change in the extent of the frame-like element ARE transverse to the traveling direction F thus effects a change in the distance between the first depth guide wheel and the second depth guide wheel ATT transverse to the traveling direction F.

The support element 10 shown on FIGS. 1 and 2 has a variable length, and is attached to the swiveling axis element 9. The variable-length support element 10 can be used to effect a height adjustment of the depth guide wheels 7, 8 relative to the frame-like element.

The processing unit 2 has a first 11.1 and a second 11.2 harrow tine, wherein the first 11.1 and the second 11.2 harrow tines are attached to the swiveling axis element 9, wherein the first 11.1 and the second 11.2 harrow tines are designed so that they can be folded between a parked position and a usable position. The harrow tines 11.1, 11.2 are shown in their usable position on FIG. 1.

Fastening the harrow tines 11.1, 11.2 to the swiveling axis element 9 prevents the distance between the two harrow tines 11.1, 11.2 from changing given a change in the extent ARE of the frame-like element 4 transverse to the traveling direction F. Rather, the two harrow tines 11.1, 11.2 are attached to the swiveling axis element 9 at a predetermined distance from each other. The distance between the two harrow tines 11.1, 11.2 is here selected according to the size of the crops in an initial growth phase. During soil cultivation in a plant row, i.e., during soil cultivation in which the two depth guide wheels 7, 8 are guided in such a way that the plant row is always located between the two wheels, the two harrow tines 11.1, 11.2 always process the plant row on both sides of the individual plants. This means that soil is loosened on both sides of each crop, and any weeds growing there are killed. Since this type of cultivation must be performed with very special care, so as not to damage the young crops, use is preferably made of harrow tines 11.1, 11.2 that have smaller dimensions by comparison to the usual harrow tines. Of course, the harrow tines cannot be too delicate in design, so as prevent frequent damage or destruction of the tines, but the diameter and elastic bendability of the tines can be selected in such a way as to be adjusted to a low growth height of the plants.

FIG. 2 shows the processing unit 2 including the frame-like element 4. The frame-like element 4 is assembled out of a first 4.1, a second 4.2, a third 4.3 and a fourth 4.4 partial element, wherein the first 4.1 and the third 4.3 partial element are comprised of a linear piece of spring steel, while the second 4.2 and the fourth 4.4 partial element consist of a U-shaped, bent piece of spring steel. The individual partial elements are firmly connected with each other, and together form a frame-like element 4 consisting of elastic spring steel. The frame-like element 4 has approximately an oval shape with two linear sections.

FIG. 2 shows the harrow tines 11.1, 11.2 in their parked position. The harrow tines are here folded up out of their usable position. The first angle chopper 15.1 is likewise folded up into its parked position, while the second angle chopper 15.2 is shown in it usable position.

The soil cultivator comprises a first, movably designed adjusting means 12.1 and a second, movably designed adjusting means 12.2. The first adjusting means 12.1 is connected via the first connecting part 13.1 with the frame-like element 4 in the area of the first partial element 4.1. The second adjusting means 12.2 is connected via the second connecting part 13.2 with the frame-like element 4 in the area of the third partial element 4.3.

An antiparallel movement of the first adjusting means 12.1 and the second adjusting means 12.2 causes the connecting parts 13.1, 13.2 to be moved either toward or away from each other. As a result, the frame-like element 4 is deformed in particular in the area of the bent partial elements 4.2, 4.4, so that the extent of the frame-like element 4 transverse to the traveling direction F changes.

The movement of the first 12.1 and the second 12.2 adjusting means is caused by an adjusting unit (not shown) that acts on the adjusting means. The adjusting unit involves a hydraulic actuator that can be actuated by means of a control device. The adjusting unit can be used to effect the movement of the first and the second adjusting means 12.1, 12.2 from the tractor, even during soil cultivation. If necessary, the width of the frame-like element 4 can thus be adjusted quickly and easily to the respective conditions on the field, wherein the soil cultivation process does not have to be interrupted.

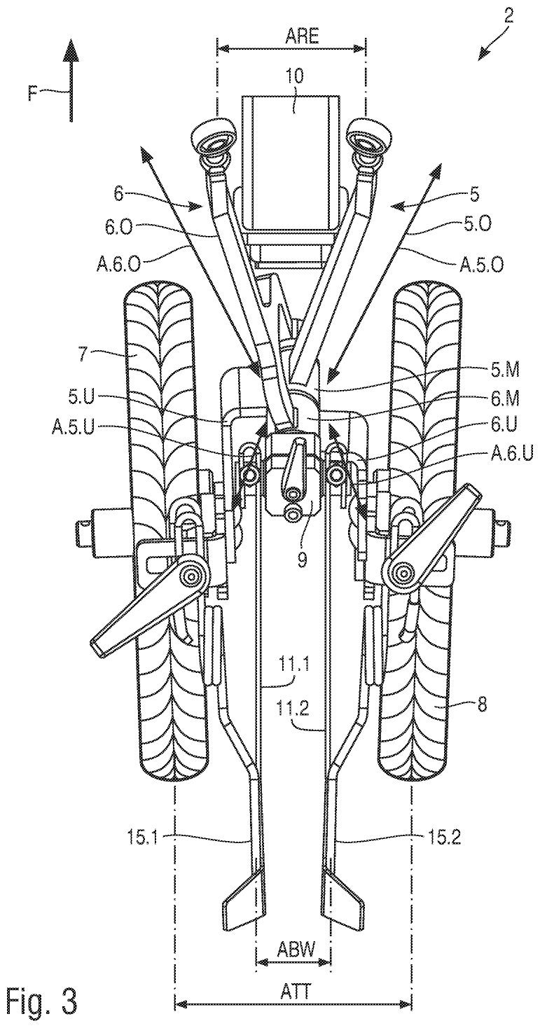

FIG. 3 presents a schematic view of the part of a processing unit 2 of a soil cultivator already shown on FIG. 1 for mechanical weed control in rows of cultivated plants according to the invention. The effects of decreasing the extent of the frame-like element 4 are illustrated on FIG. 3. As on FIG. 1, the frame-like element 4 is also not shown. As on FIG. 1, the eyelet shown at the upper end of the first connecting element 5 and the eyelet shown at the upper end of the second connecting element 6 provide means for fastening the connecting elements 5, 6 to the frame-like element 4. The change in the extent of the frame-like element 4 can thus be depicted based upon the change in the distance between the two eyelets.

A comparison of FIGS. 1 and 3 clearly shows the decrease in the distance between the two eyelets, and thus the decrease in the extent ARE of the frame-like element. Based upon the fact that the upper sections 5.O, 6.O have a larger extent than their lower sections 5.U, 6.U for both connecting elements 5, 6, a decrease in the extent of the frame-like element ARE transverse to the traveling direction F effects a comparatively smaller decrease in the distance ABW between the first soil cultivation tool 15.1 and the second soil cultivation tool 15.2 transverse to the traveling direction F.

A comparison of FIGS. 1 and 3 also reveals that a change in the extent ARE of the frame-like element transverse to the traveling direction F can effect a change in the distance ATT between the first depth guide wheel 7 and the second depth guide wheel 8 transverse to the traveling direction F. In this case, the distance ATT between the two depth guide wheels 7, 8 can be adjusted to the size of the individual plants in the crop row. During weed control in an early growth stage of the plants, the rows are processed in such a way that the individual plants are located between the two depth guide wheels. Care must here be taken that the wheels do not damage the plants. This is easily enabled by the variable distance between the wheels.

Based upon the fact that the upper sections 5.O, 6.O have a larger extent than their lower sections 5.U, 6.U for both connecting elements 5, 6, a decrease in the extent of the frame-like element ARE transverse to the traveling direction F effects a comparatively smaller decrease in the distance ATT between the first depth guide wheel 7 and the second depth guide wheel 8 transverse to the traveling direction F.

Since the two depth guide wheels 7, 8 are attached to the lower section 5.U, 6.U of the respective connecting element 5, 6, and these connecting elements 5, 6 are rigidly designed, the camber of the depth guide wheels 7, 8 changes when the connecting elements 5, 6 are swiveled. Proceeding from the basic setting shown on FIG. 1, a decrease in the extent ARE of the frame-like element 4 transverse to the traveling direction F leads to a decrease in the distance between the depth guide wheels and to a negative camber of the wheels. As a result, the depth guide wheels 7, 8 move earth outwardly away from the plant row.

### REFERENCE LIST

2 Processing unit
4 Frame-like element
4.1 First partial element of the frame-like element
4.2 Second partial element of the frame-like element
4.3 Third partial element of the frame-like element
4.4 Fourth partial element of the frame-like element
5 First connecting element
5.M Annular section of the first connecting element
5.O Upper section of the first connecting element
5.U Lower section of the first connecting element
6 Second connecting element
6.M Annular section of the second connecting element
6.O Upper section of the second connecting element
6.U Lower section of the second connecting element
7 First depth guide wheel
8 Second depth guide wheel
9 Swiveling axis element
10 Support element
11.1 First harrow tines
11.2 Second harrow tines
12.1 First adjusting means
12.2 Second adjusting means
13.1 First connecting part
13.2 Second connecting part
15.1 First soil cultivation tool
15.2 Second soil cultivation tool
ABW Distance between the first soil cultivation tool and the second soil cultivation tool
ARE Extent of the frame-like element transverse to the traveling direction
ATT Distance between the first depth guide wheel and the second depth guide wheel
A.5.O Extent of the upper section of the first connecting element
A.5.U Extent of the lower section of the first connecting element
A.6.O Extent of the upper section of the second connecting element
A.6.U Extent of the lower section of the second connecting element
F Traveling direction

What is claimed and desired to be secured by Letters Patent is:

1. A soil cultivator for mechanical weed control in rows of cultivated plants, comprising:
a frame attachable to a tractor for movement along a traveling direction, and at least one processing unit attached to the frame, wherein the at least one processing unit comprises,
a frame-like element, wherein an extent of the frame-like element can be changed transverse to the traveling direction,
at least a first soil cultivation tool attached to the frame-like element via a first connecting element,
at least a second soil cultivation tool attached to the frame-like element via a second connecting element, and
a swiveling axis element having a cylindrical design at least sectionally in cross section,
wherein the first soil cultivation tool and the second soil cultivation tool are arranged transverse to the traveling direction on different sides of the swiveling axis element,
wherein the first connecting element has a first annular section that encloses the swiveling axis element like a sleeve,
wherein the second connecting element has a second annular section that encloses the swiveling axis element like a sleeve, and
wherein the first and the second connecting elements are arranged so that they can swivel around the swiveling axis element in such a way that a change in the extent of the frame-like element transverse to the traveling direction can effect a change in a distance between the first soil cultivation tool and the second cultivation tool transverse to the traveling direction.

2. The soil cultivator according to claim 1, wherein the first connecting element has an upper section connected with the frame-like element and with the first annular section and a lower section connected with the first annular section and with the first soil cultivation tool, and the second connecting element has an upper section connected with the frame-like element and with the second annular section and a lower section connected with the second annular section and with the second soil cultivation tool.

3. The soil cultivator according to claim 2, wherein the extent of the upper section of the first connecting element in a direction going from the frame-like element to the first annular section is greater than the extent of the lower section of the first connecting element in a direction going from the first annular section to the first soil cultivation tool, and the extent of the upper section of the second connecting element in a direction going from the frame-like element to the second annular section is greater than the extent of the lower section of the second connecting element in a direction going from the second annular section to the second soil cultivation tool, wherein changing the extent of the frame-like element transverse to the traveling direction can effect a comparatively smaller change in the distance between the first soil cultivation tool and the second soil cultivation tool transverse to the traveling direction.

4. The soil cultivator according to claim 2, wherein the extent of the upper section of the first connecting element in a direction going from the frame-like element to the first annular section is less than the extent of the lower section of the first connecting element in a direction going from the first annular section to the first soil cultivation tool, and the extent of the upper section of the second connecting element in a direction going from the frame-like element to the second annular section is less than the extent of the lower section of the second connecting element in a direction going from the second annular section to the second soil cultivation tool, wherein changing the extent of the frame-like element transverse to the traveling direction can effect a comparatively larger change in the distance between the first soil cultivation tool and the second soil cultivation tool transverse to the traveling direction.

5. The soil cultivator according to claim 1, wherein the first and the second soil cultivation tools comprise a first and a second angle chopper, wherein the first angle chopper is attached to a lower section of the first connecting element, and the second angle chopper is attached to a lower section of the second connecting element.

6. The soil cultivator according to claim 1, further comprising a first and a second depth guide wheel, wherein the first depth guide wheel and the second depth guide wheel are arranged transverse to the traveling direction on different sides of the swiveling axis element, wherein the first depth guide wheel is attached to a lower section of the first connecting element, and the second depth guide wheel is attached to a lower section of the second connecting element, wherein changing the extent of the frame-like element transverse to the traveling direction can effect a change in the distance between the first depth guide wheel and the second depth guide wheel transverse to the traveling direction.

7. The soil cultivator according to claim 1, further comprising a support element, wherein the support element is attached to the swiveling axis element.

8. The soil cultivator according to claim 7, wherein the support element comprises a variable-length support element, and the variable-length support element can effect a height adjustment of the depth guide wheels relative to the frame-like element.

9. The soil cultivator according to claim 1, wherein the processing unit has at least a first and a second harrow tine, wherein the first and the second harrow tines are attached to the swiveling axis element, wherein the first and the second harrow tines are designed so that they can be folded between a parked position and a usable position.

10. The soil cultivator according to claim 1, wherein the frame-like element at least sectionally consists of an elastic material, wherein the elastic material comprises an elastomer, a thermoplastic, a rubber, or steel.

11. The soil cultivator according to claim 1, further comprising a plurality of cultivation tools on the processing unit, wherein the cultivation tools are connected with the frame-like element of the processing unit via one or several connecting means, wherein the cultivation tools comprise cultivator sweeps, colters and harrow tines.

12. The soil cultivator according to claim 1, wherein the processing unit further comprises:
a first, movably designed adjusting means, wherein the first adjusting means is connected with the frame-like element via at least a first connecting part, and a second, movably designed adjusting means, wherein the second adjusting means is connected with the frame-like element via at least a second connecting part, and
at least one adjusting unit for executing a movement of the first and the second adjusting means, wherein the movement of the first and the second adjusting means makes it possible to change the extent of the frame-like element transverse to the traveling direction.

13. The soil cultivator according to claim 12, wherein the adjusting unit can effect a linear movement of the first and the second adjusting means oriented transverse to the traveling direction, wherein the movement of the first adjusting means can be effected so as to be oriented antiparallel to the movement of the second adjusting means.

14. The soil cultivator according to claim 12, wherein the adjusting unit comprises an electric or hydraulic actuator that can be actuated by means of a control device.

15. The soil cultivator according to claim 1, further comprising a plurality of processing units with a plurality of frame-like elements arranged on the frame.
